(19) United States
(12) Patent Application Publication
(10) Pub. No.: US 2008/0251326 A1
(43) Pub. Date: Oct. 16, 2008

(54) DISC BRAKE PADS HAVING A VISUAL WEAR INDICATOR WHICH SIGNALS THE NEED FOR PAD REPLACEMENT

(76) Inventor: David A. Lundskog, American Fork, UT (US)

Correspondence Address: Angus C. Fox, III, 4093 N. Imperial Way, Provo, UT, 84604-5386, US

(21) Appl. No.: 11/736,000

(22) Filed: Apr. 16, 2007

(51) Int. Cl. F16D 66/02

(52) U.S. Cl. 188/1.11 W

(57) ABSTRACT

A new method and apparatus signals to an inspector on a cursory exterior examination of a vehicle that brake pads have reached the limit of safe wear. Brake pads are designed to release a material that has a color other than the browns and grays of conventional brake pad dust when they reach the limit of safe wear. The colored material distributes itself on the wheel of the vehicle, thereby offering telltale evidence of worn-out brake pads. A first embodiment brake pad employs a colored powdered material enclosed in at least one pocket beneath the normal wear range of the friction lining. A third embodiment brake pad employs a heat-stable, colored liquid or slurry in metal capsule. The capsule is breached by rubbing against the brake rotor when the wear limit is reached. Inorganic pigments are used for powder, slurry and friction lining colorants.

### FIELD OF THE INVENTION

This invention relates, generally, to a brake pads for vehicle disc brakes, the pad comprising a backing plate and a friction lining. More particularly, the invention relates to wear indicators which are incorporated into the brake pads, and are designed to alert the driver of a vehicle when the pads need replacing.

### BACKGROUND OF THE INVENTION

Several approaches have been used in the past to prevent damage to disc brake rotors when the friction lining on the brake pad backing plate is nearly worn away. In the 1960's, Daimler Benz Corporation fitted its vehicles with disc brake calipers having soft, fast-wearing friction linings that generated very little wear on the rotors. It was a fairly simple job to replace the brake pads, as the rotors seldom needed turning or replacement. However, to prevent the brake pad backing plates from scoring the rotor when the friction linings wore out, each disc brake caliper was fitted with a spacer that prevented the brake pad backing plates from getting too near the rotor. The benefit to such a design feature was the brake rotor was protected against damage. The downside was the total loss of braking power at an affected wheel when the backing plates came into contact with the spacer. As only the front wheels were typically equipped with disc brakes, braking force could be reduced to 20-30 percent of normal if the pads on both front wheel brakes wore out at the same time. As a practical matter, this usually did not occur. However, the sudden loss of a single front brake created a dangerous operating condition that could easily spin the vehicle around the wheel with the still functioning front brake in a panic stop. The loss of both front brakes created an equally dangerous condition, where the vehicle was virtually unstoppable.

During subsequent decades, automobile manufacturers adopted more safe methods of protecting the disc brake rotors from damage caused by worn-out friction linings. The least costly method involves the use of brake pads having a sheet metal bracket at the edge of the pad which scrapes the rotor when the friction lining nears the end of its life. As the brackets make quite a racket, it is rather embarrassing to drive a vehicle with worn pads. However, embarrassment is likely an effective tool for encouraging drivers to replace worn-out brake pads. A more costly approach to protecting brake rotors involves the use of brake pads fitted with electrical contacts that are insulated from ground as long as the friction lining is serviceable. However, when it contacts the rotor as the friction lining approaches the safe limit of wear, an electrical circuit is completed, which causes a brake warning light on the instrument panel to illuminate. This method has several drawbacks. Firstly, it requires that additional wiring be routed through the vehicle's wiring harness to each wheel. Secondly, it requires that an electrical connection be made to at least one brake pad at each wheel. For more complete protection against rotor damage, every brake pad will have an electrical connection. These connections must be made in a location that, in the winter, may be covered with high salt concentrations. In the summer, brake pad temperatures may, in stops from high speeds, exceed 1000° F. It should be obvious that maintaining the integrity of the electrical connections at the brake pad over the life of the vehicle is no trivial task.

All three of the methods discussed above for preventing worn-out brake pads from damaging brake rotors share a common drawback. A cursory exterior inspection of the vehicle is incapable of determining whether or not brake pads have reached the limit of wear. Such a feature would be particularly valuable for fleet operators and highway safety inspectors.

### SUMMARY OF THE INVENTION

The present invention provides a new method and apparatus for signaling to an inspector on a cursory exterior examination of a vehicle that brake pads have reached the limit of safe wear. An advantage with the present invention is that is compatible with and can be used in combination with the prior art methods and apparatus discussed in the Background section above. Brake pads made in accordance with the present invention are designed to release a material that has a color other than the browns and grays of conventional brake pad dust when they reach the limit of safe wear. The colored material distributes itself on the wheel of the vehicle, thereby offering telltale evidence of worn-out brake pads. Several methods are disclosed which provide for the release of the colored material.

For a first main embodiment of the invention, a distinctly colored powdered pigment, such as bright-red iron oxide powder is enclosed either in at least one pocket beneath the safe wear range of the friction lining. When the friction lining on the brake pad is new, the pocket(s) are spaced away from the rotor. However, as the friction lining wears, the rotor gets increasingly near the pocket(s). When the friction lining is worn to the limit of safe use, the pocket(s) are breached by the friction of the rotor, thereby releasing the powder. The pockets are most easily formed in apertures punched or cut in the brake pad backing plate. The pockets also extend into the friction lining up to lower limit of the safe wear range. The powder can be sealed in the pockets with a shim plate that is typically attached to the back of a brake pad.

For a second main embodiment of the invention, the friction linings of the brake pads are made with two colors of binder material. For that portion of the friction lining that corresponds to safe wear, a conventionally colored binder is employed. However, for the underlying friction lining that corresponds to material beyond the safe wear limit, a binder having a noticeably distinct color is used. As the friction lining wears into the underlying layer, the distinctly colored binder will coat the wheel and signify that the time for pad replacement has arrived.

For a third main embodiment of the invention, a metal capsule containing a heat-stable, colored liquid or slurry containing pigment is positioned adjacent the friction lining. The capsule can be spot welded or brazed to the sheet metal warning bracket that scrapes the rotor when the friction lining nears the end of its life. When the friction lining wear limit is near, a seal over the mouth of the capsule is abraded and breached by the rotor, thereby releasing the colored liquid or slurry, which sprays on the vehicle's wheel. The metal capsule can be pressurized with an inert gas, such as nitrogen or argon, so that when the capsule is breached, the slurry or fluid is expelled under pressure.

For any of the three main embodiments, the use of inorganic pigments is preferred, as they are stable at elevated temperatures. Inorganic pigments include single-metal oxides, mixed-metal oxides, and earth colors. Single-metal oxides include pigments made from titanium, zinc, cobalt, and chromium. Mixed-metal oxides include pigments such as cobalt aluminate blue, nickel antimony titanate, manganese antimony titanate, and chromium antimony titanate. Earth colors are generally made from iron oxides and lead chromates. A wide range of pigment colors is available, including green, blue, yellow, white, and red.

### BRIEF DESCRIPTION OF THE DRAWINGS

FIG. 1 is a plan view of the friction lining side of a typical brake pad which has been modified to incorporate a first embodiment of the present invention;

FIG. 2 is an elevational view of the brake pad of FIG. 1;

FIG. 3 is a plan view of the backing plate side of the brake pad of FIG. 1;

FIG. 4 is a plan view of the backing plate side of the brake pad of FIG. 1, with the shim plate removed and showing a first embodiment of the invention having a pattern of four apertures for containing the colored powder;

FIG. 5 is a plan view of the backing plate side of the brake pad of FIG. 1, with the shim plate removed and showing a alternative first embodiment of the invention having a second pattern of two apertures for containing the colored powder;

FIG. 6 is a cross-sectional view of the brake pad of FIG. 1, taken through line 6-6;

FIG. 7 is an elevational view of a second embodiment of the invention having a colored friction lining layer underlying a normal wear range friction lining layer;

FIG. 8 is an elevational view of a third embodiment of the invention having a capsule filled with a colored liquid or slurry attached to a noise-making wear indicator bracket;

FIG. 9 is a plan view of the friction lining side of the third embodiment brake pad of FIG. 8; and

FIG. 10 is an enlarged, cross-sectional view of the capsule shown in FIG. 8.

### PREFERRED EMBODIMENT OF THE INVENTION

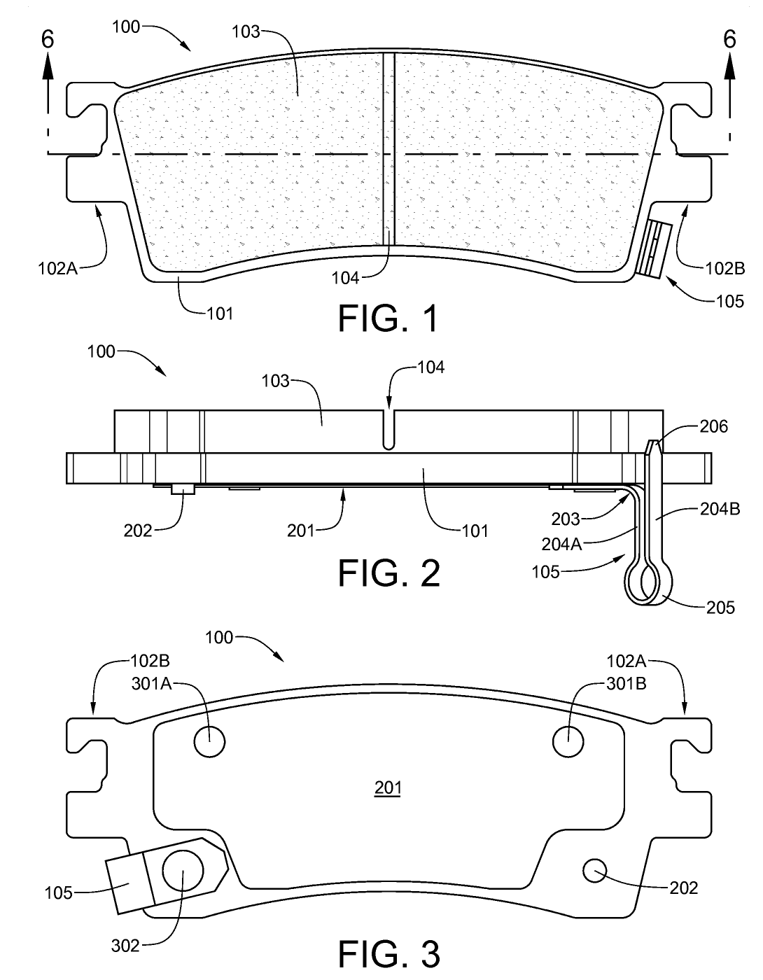

The invention will now be described with reference to the attached drawing FIGS. 1 to 10. It should be understood that the drawing figures are not necessarily drawn to scale and are meant to be merely illustrative of the invention.

Referring now to FIG. 1, the brake pad 100 includes: a backing plate 101 with brake caliper attachment ears 102A and 102B; a friction lining 103 having a central groove 104, which reduces the likelihood of the lining cracking when hot and also reduces wear on a brake rotor by capturing highly-abrasive particles such as sand at a halfway location on the pad so that they do not traverse the entire length of the pad; and a noise-making friction lining wear indicator bracket 105. All of the features visible in this view of the FIG. 1 brake pad 100 are prior art features; features related to the present invention will be seen in other views.

Referring now to FIG. 2, the brake pad 100 of FIG. 1 further includes a shim plate 201 that is riveted to the backing plate 101, and a locator stud 202 that is rigidly affixed to the backing plate 101. In this view, it can be seen that the noise-making friction lining wear indicator bracket 105 is formed from a piece of sheet metal having a 90-degree, radiused bend 203, a pair of parallel strips 204A and 204B which are connected with a looped portion 205. It will be noted that the tip 206 of strip 204B is positioned at the limit of the useful, or safe, wear range of the friction lining 103. When the friction lining 103 is worn to the extent that the tip 206 contacts the spinning brake rotor, the wear indicator bracket 105 makes an annoying noise that, hopefully, will prompt a driver to have his vehicle serviced.

Referring now to FIG. 3, the shim plate 201 is more clearly visible in this view of the backside of the brake pad 100, as are the rivets 301A and 301B which secure it to the backing plate 101. It will also be noted that the wear indicator bracket 104 is secured to the backing plate 101 with another rivet 302. The locator stud 202 is also seen head-on in this view.

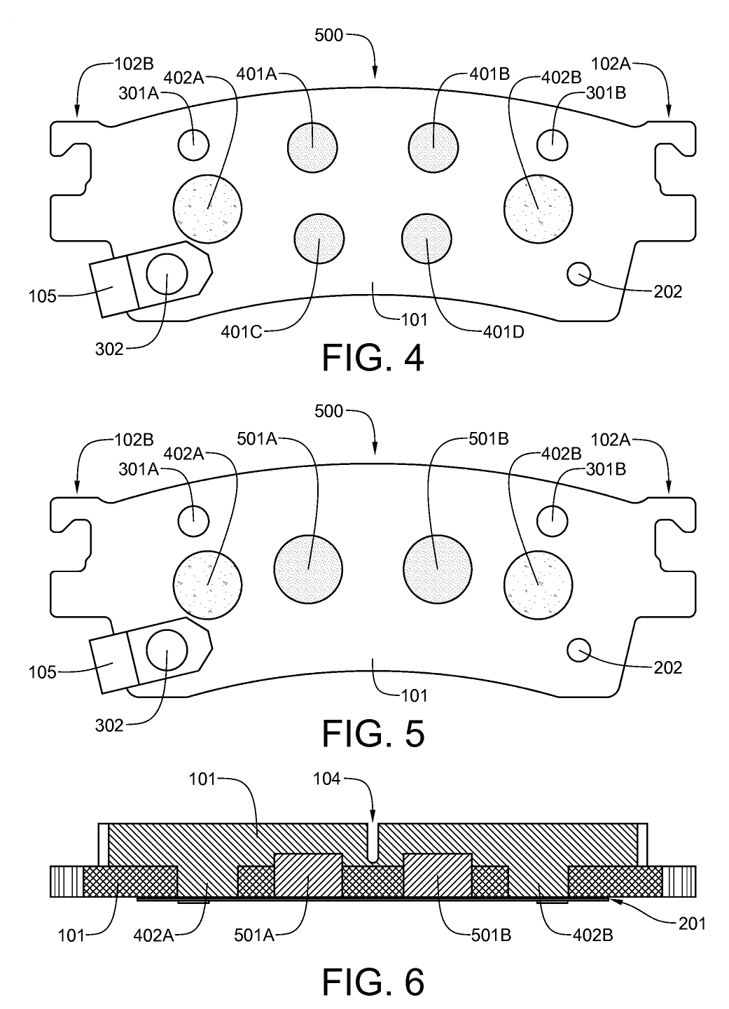

It should be noted that FIGS. 4 and 5 portray brake pads 400 and 500, respectively, with alternative pocket patterns for a first main embodiment of the new brake pad. Referring now to FIG. 4, the shim plate 201 has been removed from the backing plate 101 in order to show a first pattern of pockets 401A, 401B, 401C and 401D, which begin as apertures formed in the backing plate 101, and which extend to the maximum limit of the useful wear range of the friction lining 103. Also visible in this view are two additional apertures 402A and 402B, which have formed in the backing plate 101 and filled with friction lining material, thereby helping to secure the friction lining 103 to the backing plate 101. Each of the pockets 401A, 401B, 401C and 401D is filled with a powdered inorganic pigment 403 that is stable up to a temperature of at least 650° C. (approximately 1200° F.). Once filled, the pockets 401A-401D are sealed by the installation and riveting of the shim plate 201 to the backing plate 101. Inorganic pigments are generally crystalline in nature and highly stable at elevated temperatures. Inorganic pigments include single-metal oxides, mixed-metal oxides, and earth colors. Single-metal oxides include pigments made from titanium, zinc, cobalt, and chromium. Mixed-metal oxides include pigments such as cobalt aluminate blue, nickel antimony titanate, manganese antimony titanate, and chromium antimony titanate. Earth colors are generally made from iron oxides and lead chromates. A wide range of pigment colors is available, including green, blue, yellow, white, and red. When the friction lining is worn to the limit of the useful wear range, the pockets are exposed by continued wearing away of the friction lining material. The pigment 403 in the pockets 401A-401D will be discharged and some will coat visible portion of the wheel, thereby signifying that the worn brake pad should be replaced with a new one.

Referring now to FIG. 5, the shim plate 201 has been removed from the backing plate 101 to show an alternative pattern of pockets 501A and 501B for the new first embodiment brake pad, which though larger in diameter than those of FIG. 4, are also filled with an inorganic pigment, sealed with the shim plate 201, and function in the same manner as those of FIG. 4.

Referring now to FIG. 6, this cross-sectional view taken through the brake pad 100 of FIG. 1, which is equipped with an aperture pattern as shown in FIG. 5, shows the general shape of pockets 501A and 501B, the powdered inorganic pigment 403, and the extensions of the friction lining 103 into the securing apertures 402A and 402B.

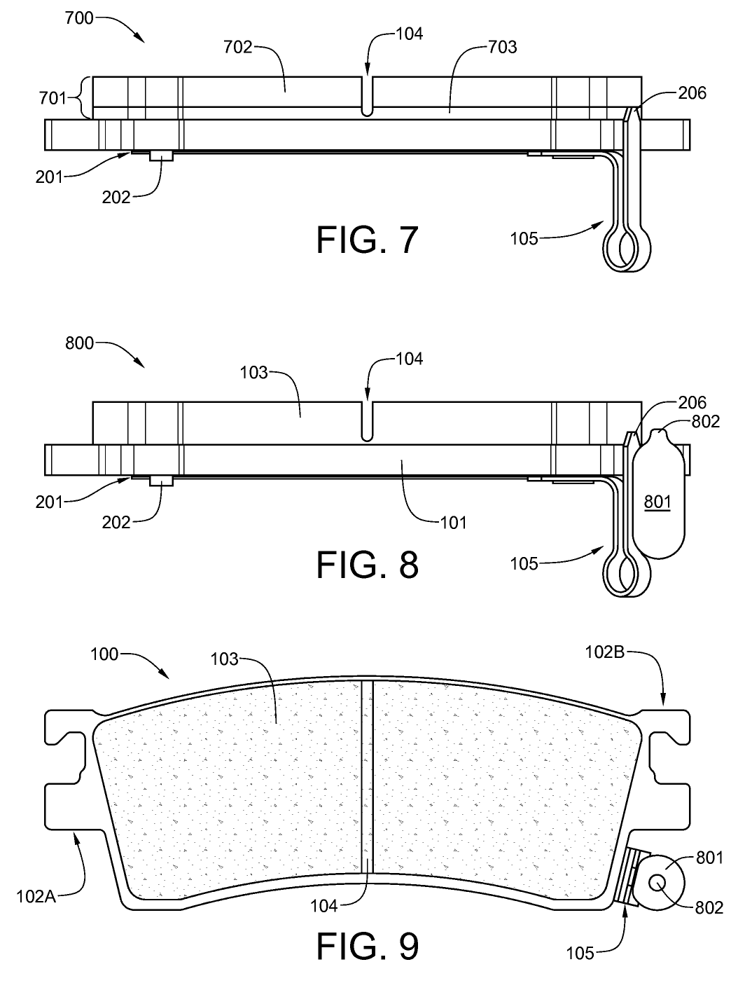

Referring now to FIG. 7, a second main embodiment of the new brake pad 700 is equipped with a layered friction lining 701. For an upper portion 702 of the friction lining 701 that corresponds to the safe wear range, a conventionally colored binder is employed. However, for the underlying portion 703 of the friction lining 701 that corresponds to material beyond the safe wear limit, a binder having a noticeably distinct color is used. Inorganic pigments are added to the binder to give it a unique and recognizable color. As the friction lining wears into the underlying portion 703 of the friction lining 701, the distinctly colored binder will coat the wheel and signify that the time for pad replacement has arrived.

Referring now to FIG. 8, for a third main embodiment of the new brake pad 800, a metal capsule 801 containing a heat-stable, colored liquid or slurry preferably containing an inorganic pigment is positioned adjacent the friction lining 103. The metal capsule 801 can be spot welded or brazed to the sheet metal warning bracket 105 that scrapes the brake rotor when the friction lining 103 nears the end of its life. When the friction lining wear limit is near, the top 802 of the capsule 801 will be abraded and breached by the rotor, thereby releasing the colored liquid or slurry, which sprays on the vehicle's wheel. The metal capsule 801 can be pressurized with an inert gas, such as nitrogen or argon, so that when the capsule is breached, the slurry or fluid is expelled under pressure.

Referring now to FIG. 9, the third main embodiment new brake pad 800 is shown from the vantage point that the brake rotor will “see” it. As the friction lining 103 wears down, the top 802 of the metal capsule 801 will worn away, thereby discharging the colored liquid or slurry.

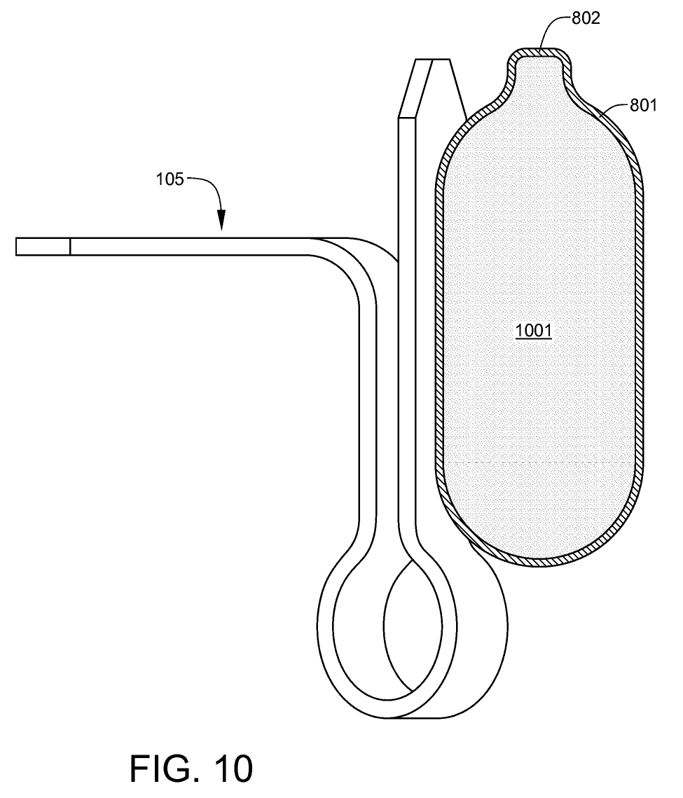

Referring now to FIG. 10, the metal capsule is shown in an enlarged, cross-sectional view which shows the colored liquid or slurry 1001 within.

Although only several embodiments of the brake pad have been heretofore disclosed and described, it will be obvious to those having ordinary skill in the art that changes and modifications may be made thereto without departing from the scope and the spirit of the invention as hereinafter claimed.

What is claimed is:

1. A disc brake pad comprising:
a backing plate;
a friction lining; and
means for releasing a material having a unique and recognizable color when the friction lining nears or reaches a limit of safe wear.

2. The disc brake pad of claim 1, wherein said means for releasing a material having a unique and recognizable color comprises a layered friction lining having an upper normal wear range layer made with a conventionally-colored binder, and an underlying layer made with a uniquely-colored and identifiable binder material, such that once the friction lining is worn through the normal wear range layer, the uniquely-colored and identifiable binder material will begin to accumulate as dust on a vehicle wheel.

3. The disc brake pad of claim 1, wherein said means for releasing a material having a unique and recognizable color comprises at least one pocket positioned beneath and immediately adjacent a normal wear range layer of the friction lining, said at least one pocket filed with colored powder having high-temperature stability, said pocket being breached when a disc brake rotor wears through the normal wear range layer, thereby causing a discharge of the colored powder.

4. The disc brake pad of claim 1, wherein said means for releasing a material having a unique and recognizable color comprises a metal capsule attached to the brake pad, said capsule containing a colored liquid or colored slurry and being breachable by frictional wear against the surface of a disc brake rotor when the rotor has worn through the a normal wear range layer of the friction lining, thereby causing a discharge of the colored liquid or slurry.

5. The disk brake pad of claim 4, wherein said capsule is pressurized with at least one generally inert gas.

6. The disk brake pad of claim 5, wherein said generally inert gas is selected from the group consisting of nitrogen, carbon dioxide, helium, neon, and argon.

7. The disk brake pad of claim 1, wherein the material having a unique and recognizable color comprises at least one inorganic pigment selected from the group consisting of single-metal oxides, mixed-metal oxides, and earth colors.

8. The disk brake pad of claim 4, wherein said metal capsule is secured to a noise-making wear indicator bracket that is rigidly affixed to said backing plate.

9. The disk brake pad of claim 3, wherein each of said at least one pocket includes an aperture formed in said backing plate.

10. The disk brake pad of claim 9, wherein each aperture and the colored powder which fills it is sealed by a shim plate that is riveted to the backing plate.

11. A disc brake pad comprising:
a backing plate;
a friction lining having an upper normal wear layer for which a conventionally-colored binder is used, and a lower layer underlying the normal wear layer for which a uniquely colored binder is used, said uniquely colored binder depositing itself on a vehicle wheel after the upper normal wear layer is worn through by a disc brake rotor.

12. The disk brake pad of claim 11, wherein said uniquely colored binder incorporates at least one inorganic pigment selected from the group consisting of single-metal oxides, mixed-metal oxides, and earth colors.

13. A disc brake pad comprising:
a backing plate;
a friction lining;
an encapsulated quantity of colored pigment that is stable to temperatures of at least 650° C., said encapsulated quantity being discharged when said friction lining is worn through a normal wear range layer, so that said colored pigment can accumulate on a vehicle wheel associated with said disc brake pad.

14. The disc brake pad of claim 13, wherein said colored pigment comprises at least one inorganic pigment selected from the group consisting of single-metal oxides, mixed-metal oxides, and earth colors.

15. The disc brake pad of claim 13, wherein said encapsulated quantity is located in at least one pocket positioned beneath and immediately adjacent the normal wear range layer of the friction lining, said at least one pocket, said pocket being breached when a disc brake rotor wears through the normal wear range layer, thereby causing a discharge of the colored powder.

16. The disk brake pad of claim 15, wherein each of said at least one pocket includes an aperture formed in said backing plate.

17. The disk brake pad of claim 16, wherein each aperture and the colored pigment which fills it is sealed at the time of pad manufacture by a shim plate that is riveted to the backing plate.

18. The disc brake pad of claim 13, wherein said encapsulated quantity is located within a metal capsule secured to the backing plate, said capsule containing a colored liquid or colored slurry and being breachable by frictional wear against the surface of a disc brake rotor when the rotor has worn through the a normal wear range layer of the friction lining, thereby causing a discharge of the colored liquid or slurry.

19. The disc brake pad of claim 18, wherein said capsule is pressurized with at least one generally inert gas selected from the group consisting of nitrogen, carbon dioxide, helium, neon, and argon.

20. The disc brake pad of claim 18, wherein said metal capsule is secured to a noise-making wear indicator bracket that is rigidly affixed to said backing plate
